(19) United States
(12) Patent Application Publication
(10) Pub. No.: US 2005/0127266 A1
(43) Pub. Date: Jun. 16, 2005

(54) Method and apparatus for displaying a wine cork

(76) Inventor: Damon S. Arney, Memphis, TN (US)

Correspondence Address: Woodard, Emhardt, Moriarty,;McNett & Henry LLP, Bank One Center/Tower, 111 Monument Circle, Suite 3700, Indianapolis, IN, 46204-5137, US

(21) Appl. No.: 10/735,547

(22) Filed: Dec. 12, 2003

(51) Int. Cl. F16M 11/00

(52) U.S. Cl. 248/694

(57) ABSTRACT

A method of displaying a used wine cork while simultaneously preventing residue on the cork from staining a surface on which the holder rests is accomplished by placing a cork from an opened wine bottle into a wine cork display holder, with the wine cork display holder including a base and at least two sidewalls. One or more end walls may also be included. The wine cork display holder may be shaped as a trough, and may slope upward from an end wall.

### FIELD OF THE INVENTION

The present invention relates generally to methods for displaying wine corks, and more particularly to a method and apparatus for displaying a wine cork while preventing soiling of the surface beneath.

### BACKGROUND OF THE INVENTION

It is common practice in fine restaurants to offer a variety of wines to their customers. When ordered, wine service at a fine restaurant can be a complicated yet delightful experience. The wine is first presented to the customer in the bottle, and then the cork is removed and offered to the customer to inspect and smell. Next, the customer is provided a sample of the wine for preliminary tasting to determine whether the wine is “corked” or otherwise spoiled, and to determine whether the temperature is correct. The wine is then served.

Heretofore the common practice in the restaurant industry was to either dispose of the cork immediately after serving or to place the cork directly upon the customer's table or a plate. Both of these options produce undesirable results. Disposal of the cork prevents the customer from further inspection of the cork, and also prevents the customer from recorking the bottle to retard oxidation or to make the wine ready to take home if they do not finish the bottle. Placing the cork directly on the table may stain the tablecloth due to wine residue left on the cork. Many restaurants use white linen tablecloths, and wine stains and wine sediment stains can be an especially troublesome problem. In addition, placing the cork directly upon the table creates a mess, even if no tablecloth is used, and a potentially unsanitary condition if the cork is to be replaced in the wine bottle.

Simply placing the cork upon a plate or other utensil takes away from the prestige and sophistication desired by customers and restaurantuers. Moreover, similar problems can emerge when consumers are enjoying wine at home or in any other situation where wine is being tasted or displayed.

A need therefore exists for an improved way to hold a wine cork after opening the bottle. The display holder and method disclosed in the present application addresses that need by providing an aesthetically pleasing location for a cork while dining at a fine restaurant. The support platform is stylish and helps to create a more sophisticated and pleasant dining experience. Moreover, the support is more sanitary than simply placing the cork upon the table as the support platform can be cleaned along with the dishes in between uses. Furthermore, by providing a proper place for a cork to be placed during a meal it prevents a restaurant or consumer from disposal of the cork allowing the restaurant or customer to recork the wine if desired.

### SUMMARY OF THE INVENTION

Briefly describing one aspect of the present invention, there is provided a method of displaying a wine cork while simultaneously preventing residue on the cork from staining a surface on which the holder rests. In the disclosed method, a wine cork from an opened wine bottle is placed into or on a wine cork display holder. The wine cork display holder is preferably shaped generally as a trough, and is preferably from about 0.25 to 4 inches in length, from about 0.5 to 1.5 inches in width, and from about 0.125 to 1.5 inches in depth. The trough may slope upward from one end to the other, and may have a cylindrical, V, U, rectangular (“␣”), arc, or irregular cross-sectional shape. One or more walls may define the trough, and one or more end walls may also be included. When an end wall is included, the trough may slope downward toward the end wall.

In some preferred embodiments the base has three walls forming a boat-like shape with one pointed end and one flat end. Two of the three walls are primarily side walls, and the third wall is an end wall. The two side walls are each between about 2 to 4 inches in length, between about 0.25 and 1.0 inches in height and have a front edge and a back edge. The end wall is between about 0.75 and 1.5 inches in length, and between about 0.25 and 1.0 inches in height. The two side walls meet at their front ends and form a curved first end of the holder. The two side walls each join the end wall at their rear ends, and form a rectangular second end of the holder. The combination of the three walls thereby forms a wedge-like shape with a curved point. The trough is completely enclosed within the three side walls of the holder.

In other embodiments the holder may have a sloped floor and only one side wall. In yet other embodiments the holder may have a circular side wall, and may hold a cork in a vertical, rather than a horizontal, orientation.

### BRIEF DESCRIPTION OF THE DRAWINGS

FIG. 1A is a perspective view of the wine cork display holder of the present invention, according to one preferred embodiment.

FIG. 1B is an end view of the wine cork display holder of FIG. 1A.

FIG. 1C is a perspective view of another embodiment of the wine cork display holder of the present invention, with an end wall being included in the holder.

FIG. 2A is a perspective view of another embodiment of the wine cork display holder of the present invention, with the holder having an incline from one end to the other.

FIG. 2B is a perspective view of another embodiment of the “inclined” wine cork display holder of the present invention, with the holder having two open ends and no end wall.

FIGS. 3A and 3B show another embodiment of the wine cork display holder of the present invention, wherein the holder is adapted to hold multiple wine corks.

FIG. 4 shows another embodiment of the wine cork display holder of the present invention, wherein the trough has “V” shaped cross section.

FIG. 5 shows another embodiment of a “V” shaped wine cork display holder of the present invention, wherein the sidewalls forming the “V” do not connect.

FIG. 6 shows another embodiment of the wine cork display holder of the present invention, wherein the holder is set in a half-spherical shaped base.

FIG. 7 shows another embodiment of the wine cork display holder of the present invention where the trough has two closed ends. In this embodiment the side walls of the holder join at one end to provide one curved end.

FIG. 8 shows another embodiment of the wine cork display holder of the present invention, where the trough has a rectangular (“␣”) cross section.

FIG. 9 shows a wine cork display holder according to another embodiment of the present invention.

FIG. 10 shows an embodiment of the wine cork display holder of the present invention where the holder has very narrow side walls allowing the cork to extend further than the length of the side walls.

FIGS. 11A and 11B show an embodiment of the present invention where the holder holds a cork “vertically” instead of “horizontally.”

### DETAILED DESCRIPTION OF THE INVENTION

For the purpose of promoting an understanding of the principles of the invention, reference will now be made to preferred embodiments and specific language will be used to describe the same. It will nevertheless be understood that no limitation of the scope of the invention is thereby intended, such alterations and further modifications of the disclosed methods and/or devices, and such further applications of the principles of the invention as described herein, being contemplated as would normally occur to one skilled in the art to which the invention relates.

As indicated above, one aspect of the present invention provides a wine cork display holder suitable for holding a wine cork to prevent spillage of residue present upon the cork. The holder preferably comprises a base member to hold the cork away from the tablecloth or other surface on which the holder may rest, with sidewalls to keep the cork from rolling off of the base. One or more end walls may also be included to further retain the cork and any liquid residue. The base may be sloped, and particularly toward an end wall, so that any liquid dripping from the cork will drain to one end, thereby keeping the remainder of the cork dry.

The wine cork display holder may be composed of any material suitable for holding a wine cork and a small amount of liquid wine, including, but not limited to, wood, plastic, metal, ceramic, stone, glass, natural materials (e.g., bone, shell, coral, etc.), or any mixture thereof. Ceramics such as bisque, porcelain, terra cotta, and china are preferred, with dishwasher-safe ceramic materials being particularly preferred. In alternative embodiments, such as wax, the wine display holder is intended to be discarded after a single use, and need not be readily cleanable at all.

The wine cork display holder is sized to receive a standard wine bottle cork. As is known to the art, such corks are generally between about ¾ inch and 1 inch in diameter, with about 7/8 inch diameters being most common. Wine cork lengths are typically between about 1.5 and 2.5 inches, with lengths of about 2 inches being particularly common.

Accordingly, the wine cork display holder preferably has a base member that is sized to receive corks of such size, with the sidewalls, of the base being spaced apart by a distance equal to, or slightly greater than, the diameter of a typical cork. The sidewalls may vary from about 0.25 to about 4 inches in length, preferably from about 1.0 to about 3.0 inches, and most preferably from about 2 inches to about 2.5 inches. The side walls are spaced between about 0.5 and 1.5 inches apart, preferably about 0.75 inch to 1.25 inches apart, and most preferably about 1.0 inches apart. The height of the walls is preferably between about 0.125 and 1.5 inches, with heights of 0.25 to 1.0 inches being more preferred, and heights of 0.25 to 0.75 being most preferred.

The holder may slope upward/downward from one end to the other. In addition, the base may have a front wall and/or a rear wall (alternatively referred to as end walls). When an end wall is included, the holder preferably slopes toward an end wall.

The wine cork holder is preferably shaped as a trough. The trough is generally sized to snugly or loosely contain a wine cork. The length of the trough generally varies between about 0.25 and 4 inches, with 1 to 3 inches being preferred, and about 2 to 2.5 inches being most preferred so as to correspond to the length of a common wine cork. The width of the trough varies from about 0.5 inches to 1.5 inches, with widths between about 0.75 and 1.25 inches being preferred, and about 1 inch being most preferred, depending on whether it is desired to loosely or snugly accept a common wine cork. The depth of the trough is generally between about 0.125 and 1.5 inches, with depths of between about 0.25 and 1 inch being preferred, and about 0.25 and 0.75 being most preferred. The cross sectional shape of the trough can be a variety of suitable shapes such as cylindrical, V-shaped, U-shaped, rectangular, irregular, or arc-shaped. Arc-shaped is defined as a shape formed by the smaller or larger portion of the circumference of a circle formed by the intersection of the circle with a secant. The trough may slope from the front wall to the rear wall, from one sidewall to the other sidewall or some combination of both.

In use, the wine cork display holder is placed on a table or other surface, and a wine cork is placed thereon after opening a wine bottle and removing the cork. If a holder with a sloped base is used, the cork is preferably placed in the holder with the wettest end of the cork at the lowest end of the holder. The holder keeps any wine residue (which may be liquid or sediment) on the cork from contacting the surface on which the holder rests, such as the tablecloth of a restaurant or home, or other surface where wine is presented or displayed.

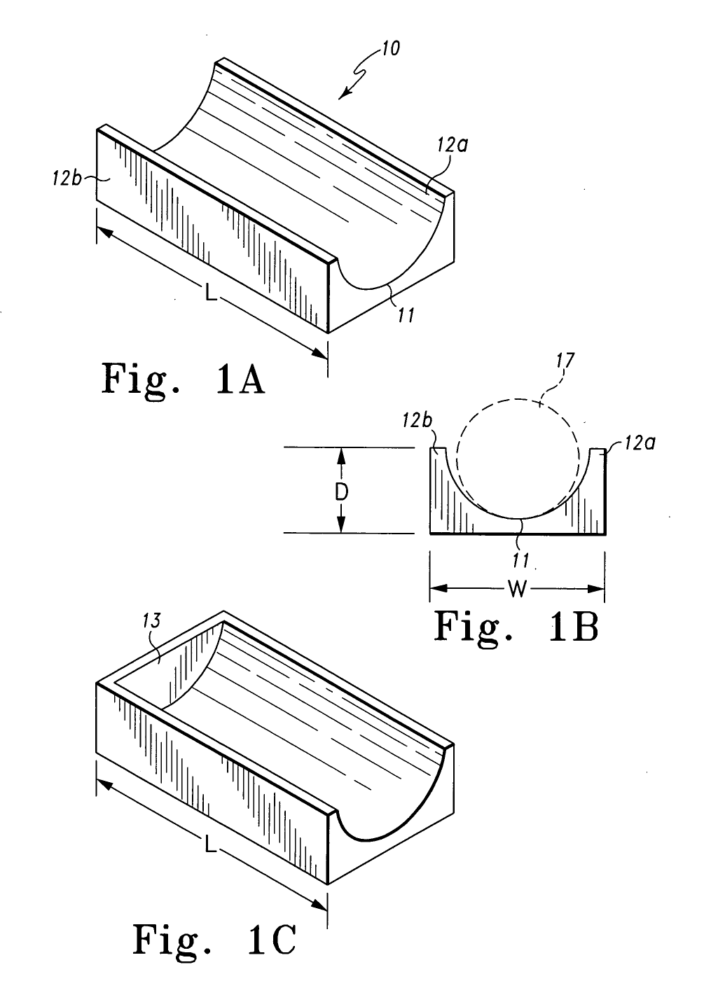

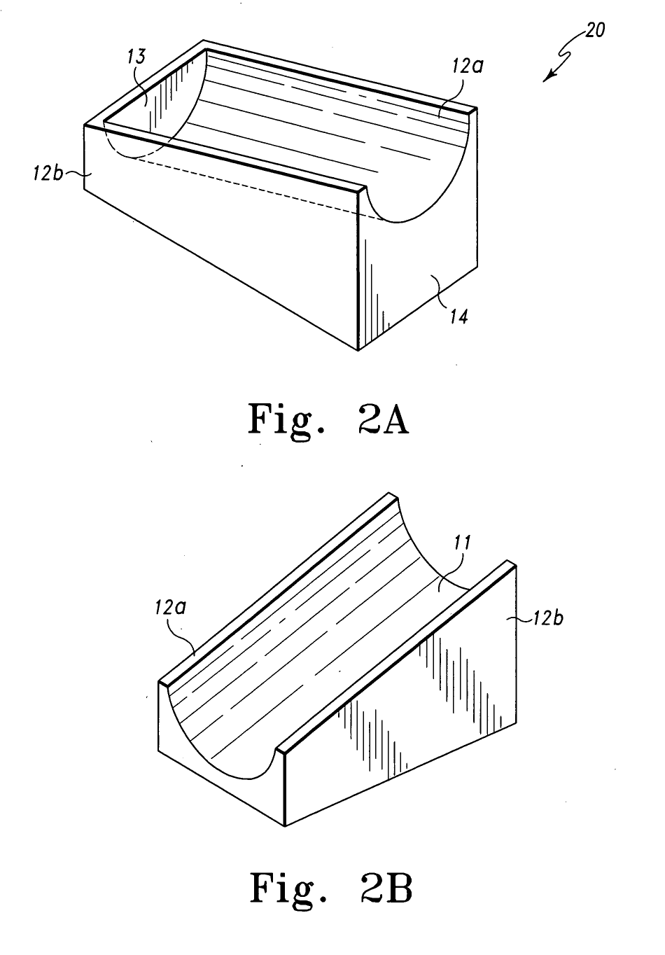

Referring now to the drawings, FIGS. 1 and 2 show a preferred embodiment of the wine cork holder of the present invention. In the illustrated embodiment holder 10 comprises a trough having a base portion 11 (also called a floor) and a pair of sidewalls 12a and 12b. Illustrated trough 10 has a length “L” of about 2¼ inches, a depth “D” of about ¼ inch, and a width “W” of about 3/4 inch. Accordingly, each sidewall has a length of about 2½ inches in the illustrated device. The height of each sidewall depends on the “thickness” of the floor, but generally extends about ¼ inch above the floor throughout its length.

A first end wall 13 is included in the illustrated device to join sidewalls 12a and 12b at one end. The height of end wall 13 corresponds to the height of the side walls.

As illustrated in FIGS. 2A and 2B, holder 20 may slope downwardly from one end to the other. In the illustrated device the holder slopes toward end wall 13, to assist in containing wine residue.

As shown in FIGS. 1 and 2, the trough of the holder may have a cross sectional shape that is arc-shaped, so as to be effective for conforming to the shape of the cork 17 being displayed.

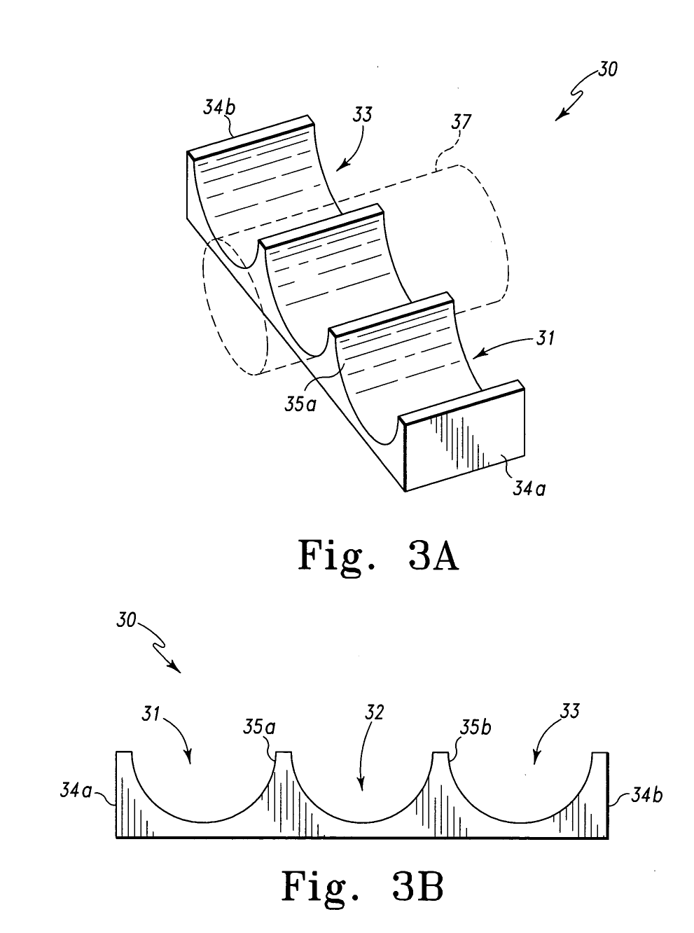

FIG. 3 shows an alternative embodiment of inventive wine cork holder, showing how multiple corks may be displayed on a single device. Accordingly, multiple troughs 31, 32, and 33 are provided in holder 30. In this illustrated embodiment, troughs 31, 32, and 33 are shorter than a standard cork, to allow easy placement and removal of cork 35.

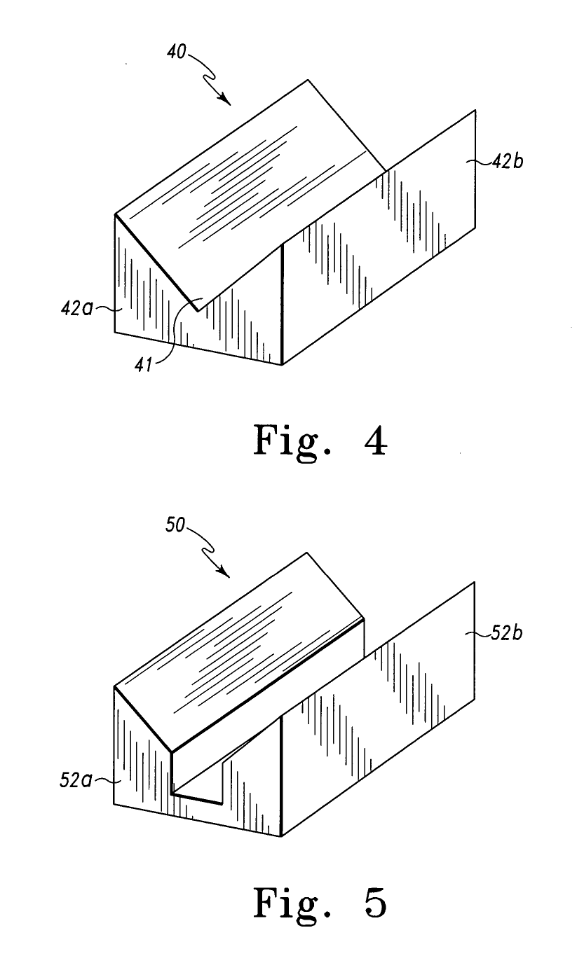

FIG. 4 shows an embodiment of the disclosed invention in which the trough has a “V” shape. In this embodiment sidewalls 42a and 42b join to form base 41.

FIG. 5 shows an embodiment similar to that shown in FIG. 4, but with the sidewalls not connecting. Accordingly, in FIG. 5 there is no “floor” to the “trough,” and the cork is retained by resting on sloped sidewalls 52a and 52b of holder 50.

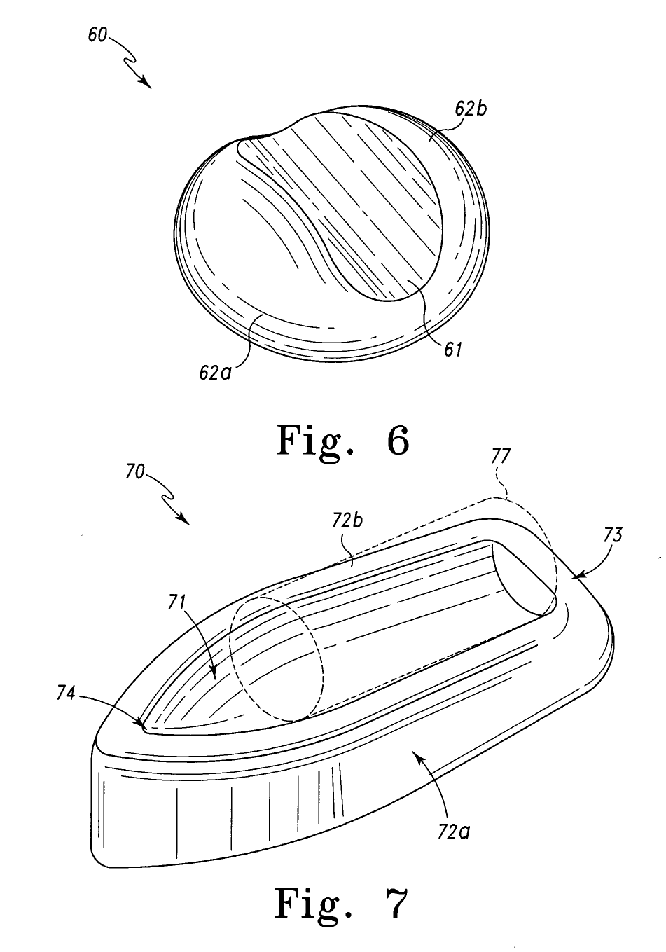

FIG. 6 shows an embodiment of the wine cork display holder of the present invention, with holder 60 comprising a “trough” 61 set in a half-spherical shaped base. Side walls 62a and 62b are formed in the base to define the trough.

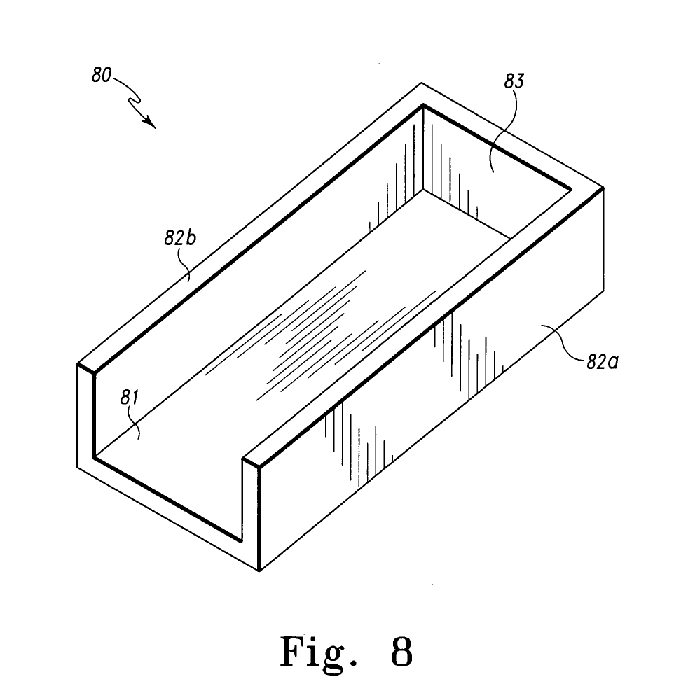

FIG. 7 shows another preferred embodiment of the invention. Wine cork display holder 70 has base member 71, a first sidewall 72a, a second sidewall 72b, and an end wall 73. First and second sidewall 72a and 72b are each about 2½ inches in length and about 3/4 inches in height, while end wall 73 is about 1 inch in length and ¾ inch in height. As shown in the drawing, first sidewall 72a joins second sidewall 72b at one end of each wall, and forms a curved section at one end of the trough. The other end of each sidewall (72a and 72b) joins end wall 73 to complete the trough. As with other illustrated devices, the trough may be sloped toward either end. In the embodiment illustrated in FIG. 7, the holder slopes toward end 73.

FIG. 8 shows a wine cork display holder 80, having a floor 81 and sidewalls 82a and 92b. The cross sectional form of holder 80 is rectangular (“␣”). As with other illustrated devices, the trough may be sloped toward either end.

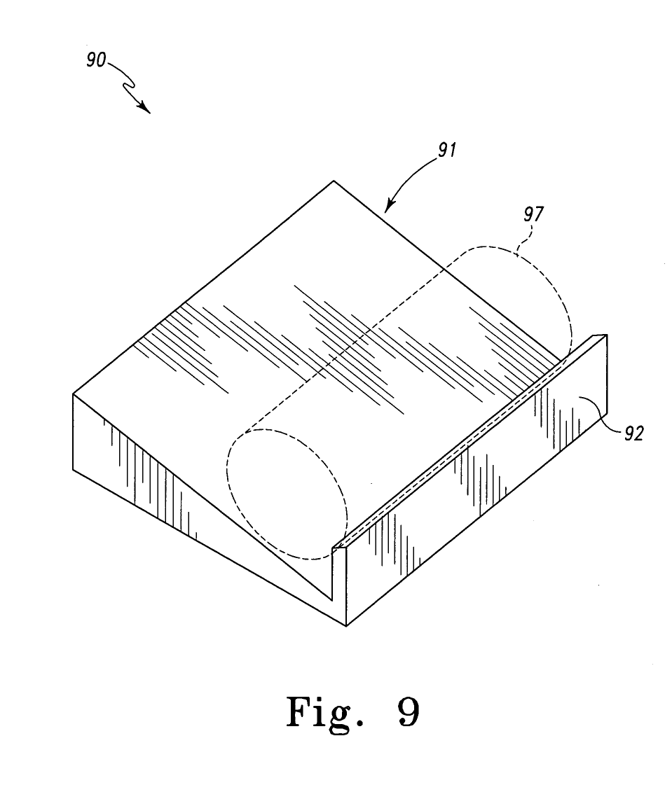

FIG. 9 shows another embodiment of a wine cork display holder, with holder 90 comprising only a base member (or platform) and one sidewall. Accordingly, as shown in the Figure, holder 90 has only a sloped platform or floor 91 and one sidewall 92, with the slope of the platform causing the wine cork to rest against sidewall 92.

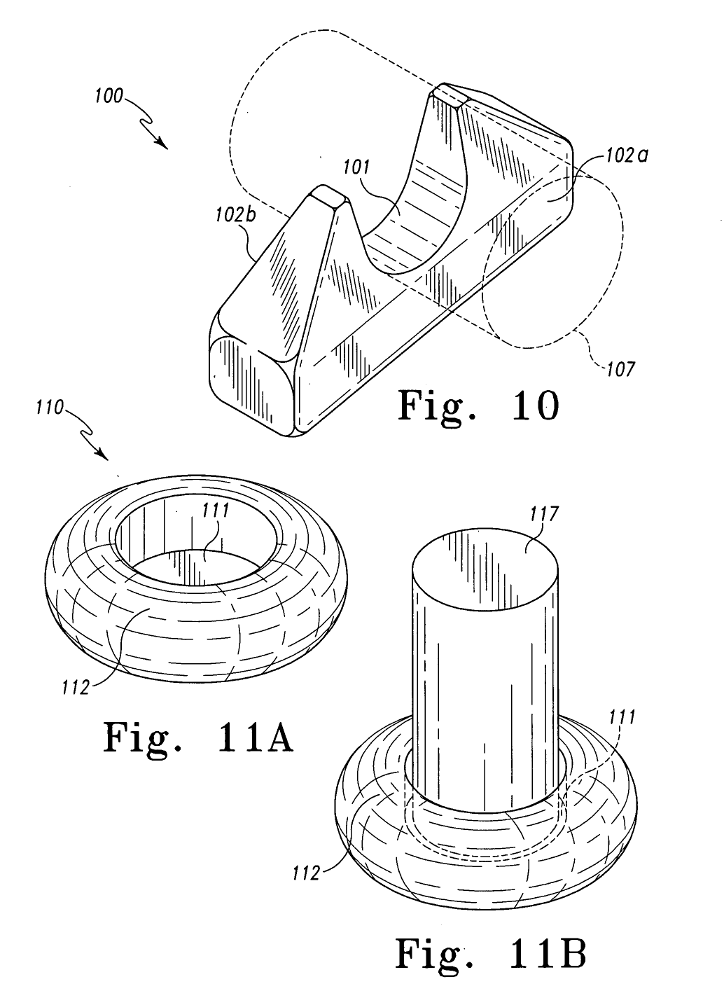

FIG. 10 shows yet another preferred embodiment of a wine cork display holder. In this embodiment holder 100 comprises a very short trough 101 defined by sidewalls 102a and 102b. In this embodiment trough 101 is less than 1.0 inch in length, and may be no more than 0.5 inches. Trough 101 is arc-shaped in the illustrated embodiment, although other cross sectional shapes may be used as mentioned above.

FIG. 11 shows an embodiment of the wine cork holder where the holder holds the cork “vertically” instead of “horizontally.” In this embodiment, holder 110 comprises a base 111 with a side wall 112 defining an indent sized to receive the end of a cork. Side wall 112 preferably forms a circular indent, and preferably has a diameter approximately equal to the diameter of a cork to be displayed.

While the invention has been illustrated and described in detail in the drawings and foregoing description, the same is to be considered as illustrative and not restrictive in character, it being understood that only the most preferred embodiments have been shown and described, and that all changes and modifications that come within the spirit of the invention are desired to be protected. In addition, all publications cited herein are indicative of the abilities of those of ordinary skill in the art and are hereby incorporated by reference in their entirety as if individually incorporated by reference and fully set forth.

1. A method of displaying a used wine cork while simultaneously preventing residue on the cork from staining a surface on which the holder rests; said method comprising placing a cork from an opened wine bottle into a wine cork display holder, wherein said wine cork display holder comprises a base and at least two sidewalls.

2. The method of claim 1 wherein at least one of said at least two sidewalls has a length of between 0.25 inches and 4.0 inches.

3. The method of claim 1 wherein said at least two sidewalls comprises a pair of sidewalls spaced between 0.5 inches and 1.5 inches apart.

4. The method of claim 1 wherein said base combines with said at least two sidewalls to form a trough.

5. The method of claim 4 wherein said trough has a cross-sectional shape of a “U.”

6. The method of claim 4 wherein said trough has a cross-sectional shape of a “V.”

7. The method of claim 4 wherein said trough has a cross-sectional shape of a “␣.”

8. The method of claim 1 wherein said base has a first end and a second end, and is sloped upward from said first end to said second end.

9. The method of claim 1 wherein said wine cork display holder further includes at least one end wall.

10. The method of claim 9 wherein said base has a first end and a second end, and said end wall is positioned at said first end of said base, and said base is sloped upward from said first end to said second end.

11. The method of claim 1 wherein said wine cork display holder further includes at least two end walls.

12. A wine cork display holder comprising a base and a pair of sidewalls; wherein at least one of said pair of sidewalls has a length of between 0.25 inches and 4.0 inches; and wherein said pair of sidewalls is spaced between 0.5 inches and 1.5 inches apart.

13. The wine cork display holder of claim 12 wherein said base combines with said pair of sidewalls to form a trough.

14. The wine cork display holder of claim 13 wherein said trough has a cross-sectional shape of a “U.”

15. The wine cork display holder of claim 13 wherein said trough has a cross-sectional shape of a “V.”

16. The wine cork display holder of claim 13 wherein said trough has a cross-sectional shape of a “␣.”

17. The wine cork display holder of claim 13 wherein said wine cork display holder further includes at least one base member to support said trough.

18. The wine cork display holder of claim 13 wherein said trough slopes downward from a first end of said trough to a second end of said trough.

19. The wine cork display holder of claim 12 wherein said wine cork display holder further includes at least one end wall.

20. The wine cork display holder of claim 19 wherein said trough slopes downward from a first end of said trough to a second end of said trough.

21. The wine cork display holder of claim 12 wherein said wine cork display holder further includes at least two end walls.

22. A method of displaying a wine cork while simultaneously preventing residue on the cork from staining a surface on which the holder rests; said method comprising placing a cork from an opened wine bottle into a wine cork display holder, wherein said wine cork display holder comprises a base member, side walls, and a trough; wherein said side walls form a wedge-like shape with a curved point comprising a first side wall between about 2 to 4 inches in length, between about 1/2 inch to 1½ inches in height, a front edge and a back edge; a second side wall between about 2 to 4 inches in length, between about 1/2 inch to 1½ inches in height, a front edge and a back edge, and a third wall between about ¾ to 1½ inches in length, between about 1/2 inch to 1½ inches in height, a front edge and a back edge; wherein the front edge of said first side wall and the front edge of said second side wall meet and form a curve for about the first quarter of the length of said first side and said second side, and the back edge of said first side meets with the front edge of said third side and the back edge of said second side meets with the back edge of said third side thereby forming a wedge-like shape with a curved point; said trough further comprises two side walls between about 3½ to 1/2 inches in length and between about 1½ to 1/8 inches in depth, and an end wall between about 1½ to 3/4 inches in length and between about 1½ to 1/8 inches in depth; wherein said trough side walls and ends walls form a similar wedge-shape with a curved point comparable to the size of said base and said trough is completely enclosed within said three side walls.

23. A wine cork display holder for displaying a wine cork having wet wine residue thereon, while simultaneously preventing the residue from staining a surface on which the holder is placed; wherein said wine cork display holder comprises a base member, side walls, and a trough; wherein said side walls form a wedge-like shape with a curved point comprising a first side wall between about 2 to 4 inches in length, between about 1/2 inch to 1½ inches in height, a front edge and a back edge; a second side wall between about 2 to 4 inches in length, between about 1/2 inch to 1½ inches in height, a front edge and a back edge, and a third wall between about ¾ to 1½ inches in length, between about 1/2 inch to 1½ inches in height, a front edge and a back edge; wherein the front edge of said first side wall and the front edge of said second side wall meet and form a curve for about the first quarter of the length of said first side and said second side, and the back edge of said first side meets with the front edge of said third side and the back edge of said second side meets with the back edge of said third side thereby forming a wedge-like shape with a curved point; wherein said trough further comprises two side walls between about 3½ to 1/2 inches in length and between about 1½ to 1/8 inches in depth, and an end wall between about 1½ to 3/4 inches in length and between about 1½ to 1/8 inches in depth; said trough side walls and ends walls form a similar wedge-shape with a curved point comparable to the size of said base and said trough is completely enclosed within said three side walls.
